(19) United States
(12) Patent Application Publication
(10) Pub. No.: US 2010/0328815 A1
(43) Pub. Date: Dec. 30, 2010

(54) MAGNETIC DISK DEVICE

(75) Inventors: Tetsuya Nakatsuka, Fujisawa (JP); Masato Nakamura, Hitachinaka (JP); Satoshi Kaneko, Yokohama (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 12/811,673

(22) PCT Filed: Jan. 29, 2009
(86) PCT No.: PCT/JP2009/051424

§ 371 Date: Aug. 12, 2010

(30) Foreign Application Priority Data
Feb. 1, 2008 (JP) 2008-022264

(51) Int. Cl. G11B 5/127

(52) U.S. Cl. 360/110; G9B/5.04

(57) ABSTRACT

Due to a difference in coefficient of linear expansion between the constituent material of the flange and the constituent material of the base of the feedthrough, the solder material which joins these materials is unable to withstand the thermomechanical loading that is generated between these heterogeneous materials during their actual usage for a long period and, as a result, cracks formed in the solder-joined portion therebetween create low-density gas leakage paths that reduce actual lifespan to less than 5 years. Disclosed is a magnetic disk device comprising a magnetic disk, a magnetic head for recording and reproducing information onto and from the magnetic disk, a base, a feedthrough solder-joined to the base, and a solder-joined portion for joining the base and the feedthrough, wherein a recess portion is provided in the perimeter edge of the solder-joined portion of the base.

### INCORPORATION BY REFERENCE

The present application claims priority from Japanese application JP2008-022264 filed on Feb. 1, 2008, the content of which is hereby incorporated by reference into this application.

### TECHNICAL FIELD

The present invention relates to a magnetic disk device suitable for enclosing a low-density gas, such as helium gas, inside the device.

### BACKGROUND ART

In response to demands for larger capacity and higher recording density, recent magnetic disk devices rotate a disk and driving a head gimbal assembly 314, respectively, at high speeds. Consequently, significant air turbulence (windage) occurs, and generate in turn vibration at a magnetic disk 312 and the head gimbal assembly 314. The windage vibration becomes a major obstacle in positioning a magnetic head 315 on a track on a disk recorded at high density. Since windage is attributable to air turbulence, windage is randomly generated and predicting intensity or a cycle thereof is difficult. As a result, swift and accurate positioning control may become a complicated and difficult process. In addition, windage vibration also generates a noise that undermines the silentness of a device.

Problems caused by the action of air in a device due to high-speed rotation other than the above include an increase in power consumption. When the disk 312 is rotated at high speed, air in the vicinity of the disk 312 is dragged and rotated. On the other hand, air away from the disk 312 remains stationary. Accordingly, a shear force is generated between the air in the vicinity of the disk 312 and the air away from the disk 312. The shear force becomes a load that acts to stop the rotation of the disk 312. This is called windage loss and the windage loss becomes greater as the speed of rotation is higher. A motor requires significant output as well as significant power in order to rotate at high-speed against the windage loss.

Conventionally, there have been ideas which focus on a proportional relationship of windage and windage loss to the density of gas inside a device, and involve enclosing a low-density gas in place of air inside a sealed magnetic disk device to reduce the windage and windage loss.

While hydrogen, nitrogen, helium and the like are considered as the low-density gas, helium is considered to be best suited due to its effectiveness, stability, and safety in view of actual usage. A magnetic disk device that seals helium gas is capable of solving the problems described above as well as realizing swift and accurate positioning control, power saving, and favorable silentness. In addition, when power saving is not a concern, rotation of the magnetic disk 312 and driving of the head gimbal assembly 314 can be realized at even higher speeds, thereby improving device performance.

However, since helium has an extremely small molecular size and a large diffusion coefficient, chassis used in ordinary magnetic disk devices are low in airtightness and has problems that helium easily leaks out during normal usage and performance cannot be maintained.

In consideration thereof, conventional art such as Patent Document 1 has been proposed. The conventional art will be described below.

FIG. 6 illustrates an example of a cross-sectional view of a sealed magnetic disk device described above. In this case, a joint portion of a base 200, on which with a device component 210 is mounted, and a cover 220 are raised as a high risk of helium leakage location in the chassis. In order to completely seal this joint portion, an upper part of a side wall of the base 200 and the cover 220 are laser-welded or solder-joined at a joint position 240.

When laser welding or solder joining is performed, materials of the base 200 and the cover 220 must be selected in view of durability and reliability of the laser weld or the solder joint, as well as cost. For example, are selected a chassis molded by an aluminum die-cast and an aluminum cover formed by pressing or by cutting; or a base formed by cold-hammering from an aluminum alloy having relatively low copper and magnesium contents and an aluminum cover formed by pressing or by cutting.

In addition, as another location in the chassis having a high risk of helium leakage, is raised a small opening on a bottom face of the base 200, through which electric wiring for connecting an FPC assembly inside the chassis and a circuit board outside of the chassis is to be passed. In order to completely seal the opening and perform electric wiring, a feedthrough 250 having a plurality of pins 260 such as illustrated in FIG. 6 is used to connect the wiring on the FPC assembly-side to a pin inside the chassis and wiring on the circuit board-side to a pin outside of the chassis.

FIGS. 7 and 8 respectively illustrate a side view and a top view of a joining structure of the magnetic disk device in which the feedthrough 250 and the base 200 have been solder-joined 300.

A flange 252 of the feedthrough 250 is solder-joined 300 to a stepped portion of the opening on the bottom face of the base 200 at a joint position 270 with the base 200. The flange 252 has a plurality of steel pins 260 so as to extend in a direction perpendicular to a plane of the flange 252. A space between the flange 252 and the steel pins 260 is filled with a sealing material 280 such as glass or ceramic so as to surround the steel pins 260.

A material of the flange 252 is selected so as to match the materials of the sealing material 280 and the base 200 and to reduce stress acting on the joint position 270. When the base 200 is aluminum, the flange 252 is either a nickel alloy or a stainless steel.

### PATENT DOCUMENT 1: US Publication No. 2005/0068666

### DISCLOSURE OF THE INVENTION

### Problems to be Solved by the Invention

A base (chassis) and a feedthrough are typically joined using a solder material. A soldering process of the feedthrough and the base is performed according to the following procedure.

(1) Flux is applied on the nickel-plated feedthrough and parts of the base where wettability is required.
(2) The feedthrough is disposed at a stepped portion of a base opening.
(3) Flux is supplied to a gap created between the feedthrough and the base due to the stepped portion of the base, and an elliptical solder is disposed.
(4) The entire base on which the feedthrough is mounted is heated by a reflow furnace.
(5) After heating and then cooling, a residue of the flux on the base and the like is cleaned off.

FIG. 7 illustrates a cross section of a joining structure after soldering. A melted solder 300 is distributed by wet-spreading across a narrow gap between the feedthrough 250 and the base 200.

FIG. 9 illustrates an enlarged view of the solder joint 300. A first face C of the surface of the flange 252 and a first face D of the surface of the base 200, and a second face E of the surface of the flange 252 and a second face F of the surface of the base 200 respectively sandwich the solder as illustrated in FIG. 9, and are respectively parallel to each other. A major portion of the solder 300 is caught in a gap between the surface of the flange 252 and the surface of the base 200, and is planarly spread thin.

Since the material of the flange 252 is kovar (coefficient of linear expansion is approximately 5 ppm/° C.) that is an iron-based material and the material of the base 200 is an aluminum alloy (coefficient of linear expansion is approximately 12 ppm/° C.) in many cases, there is a difference in coefficients of linear expansion between the members. Accordingly, there is a problem that the solder material 300 of the gap is unable to withstand the thermomechanical load generated between the heterogeneous materials during their actual usage for a sustained period of time and cracks are generated in the solder 300 of the gap.

When a heat cycle test of the joined portion is carried out as an accelerated test by using Sn-3Ag-0.5Cu (unit: weight percent) whose joint reliability is among the highest in lead-free solders as the joining solder to form the joint shape described above, the actual lifespan does not reach 5 years in some cases and cracks are generated in the solder-joined portion 300 and form low-density gas leakage paths.

While the cracks in the solder-joined portion 300 occur due to a difference in coefficients of linear expansion between the flange 252 and the base 200, the coefficient of linear expansion of the material of the flange 252 (kovar) is significantly smaller than that of the material of the base 200 (aluminum alloy). This is because the sealing material 280, such as glass, ceramic or the like, is used for insulation between the flange 252 and steel pins 260 for electric signal transmission of the feedthrough 250 as illustrated in FIG. 7. It is necessary to reduce the difference in coefficients of linear expansion between the sealing material 280 and the flange 252 in order to suppress the formation of a gap between the two materials due to a temperature change in the usage environment and leakage of a low-density gas that travels along the gap.

Accordingly, an object of the present invention is to realize a hermetically-sealed magnetic disk device having a highly reliable solder-joined structure that is less likely to leak low-density gas even when the coefficient of linear expansion of the material of the flange 252 is significantly smaller than that of the material of the base 200.

### Means for Solving the Problems

Representative aspects of the invention disclosed in the present application may be summarized as follows.

(1) A magnetic disk device including: a magnetic disk; a magnetic head that records/reproduces information onto/from the magnetic disk; a base; a feedthrough joined to the base by solder; and a solder-joined portion joining the base and the feedthrough, wherein a recess portion is formed on the base in a periphery of the solder-joined portion.
(2) The magnetic disk device according to (1), wherein a plurality of the recess portions are formed.
(3) The magnetic disk device according to (2), wherein the recess portions are respectively formed on a first face-side and a reverse side of the first face of the base.

### ADVANTAGES OF THE INVENTION

According to the present invention, a hermetically-sealed structure using a solder joint can be realized, that improves leakage lifespan from a feedthrough joint portion of a low-density gas enclosed inside a chassis and suppresses leakage of the low-density gas during actual usage.

Other objects, features and advantages of the invention will become apparent from the following description of the embodiments of the invention taken in conjunction with the accompanying drawings.

### BEST MODE FOR CARRYING OUT THE INVENTION

FIG. 5 illustrates a top view of a hermetically-sealed magnetic disk device according to the present invention, from which a cover of a chassis has been removed. In FIG. 5, a base 310 constituting a chassis is mounted with a spindle motor 311 and a magnetic disk 312 as an information recording/reproducing medium that is rotationally driven by the spindle motor 311. Also mounted are an actuator assembly 313 including a voice coil motor and a head gimbal assembly 314 that is rotationally driven by the actuator assembly 313. A magnetic head 315 that records/reproduces information onto/from the magnetic disk 312 is mounted on a distal end of the head gimbal assembly 314 via a slider having an air bearing surface (ABS) between the magnetic disk 312. Recording and reproducing are performed when the head gimbal assembly 314 is rotationally driven in a radial direction of the magnetic disk 312 and the magnetic head 315 is positioned on the magnetic disk 312. In addition, an FPC assembly 316 connects the magnetic head 315 and the various motors to a circuit board outside of the chassis, that controls driving of the magnetic head 315 and the various motors, and transmits information to be recorded or reproduced by the magnetic head 315 and currents for driving the respective motors. The magnetic disk device is operated by the spindle motor 311, the magnetic disk 312, the actuator assembly 313, the head gimbal assembly 314, the magnetic head 315 and the FPC assembly 316 inside the aforementioned chassis, and by the circuit board outside of the chassis. A hermetically-sealed magnetic disk device is created by injecting helium into the chassis mounted with the constituent members of the magnetic disk device.

The hermetically-sealed magnetic disk device is provided with a joining structure that joins a feedthrough and the base 310 by a solder material so as to prevent leakage of helium inside the chassis from a small opening on a bottom face of the base 310. The present invention proposes a joining structure having a highly reliable solder-joint structure that is less likely to cause leakage of the low-density gas.

Hereinafter, embodiments of the joining structure of the magnetic disk device according to the present invention will be described.

### First Embodiment

A first embodiment will be described with reference to FIG. 1. FIG. 1A is a cross-sectional view of a joining structure of a magnetic disk in which a base 35 and a feedthrough 32 are joined by a solder-joined portion 101. An upper side of the joining structure is an outer side of the base 35 and a lower side of the joining structure is an inner side of the base 35. A low-density gas is hermetically sealed in the base 35. In the present embodiment, a recess portion 40 that does not penetrate the base 35 is formed at least a part of a periphery of the solder-joined portion 101. In addition, FIG. 1B illustrates a top view of the joining structure illustrated in FIG. 1A. FIG. 1A is a cross-sectional view taken along X-Y in FIG. 1B. The recess portion 40 on the base 35 surrounds the feedthrough 32.

Cracks are generated at the solder-joined portion 101 which is responsible to a leakage of low-density gas, that is the problem to be solved by the present invention, since an excessive load is applied on the solder-joined portion 101. It is well known that high reliability can be achieved by reducing stress on the solder-joined portion 101 by increasing a total amount of solder and reducing stress per unit volume of the solder. To this end, the base 35 and the flange 31 are respectively structured as illustrated in FIG. 1 so as to increase the total amount of solder of the solder-joined portion 101 in the present invention.

In the present embodiment, the presence of the recess portion 40 enables the base 35 near the recess portion to be readily deformed. Therefore, stress generated on the respective members due to a temperature change of a product caused by an environment of the product or heating from the product can be distributed to the base 35 near the recess portion as well as on the solder-joined portion 101. As a result, thermomechanical load on the solder-joined portion 101 can be reduced to prevent the occurrence of cracks at the solder-joined portion 101 and suppress low-density gas leakage paths.

In this case, a width W of the recess portion 40 is desirably not smaller than 0.2 mm. This is because the molten solder easily spreads in the recess portion 40 through capillary action as the width W of the recess portion 40 is narrower when the molten solder overflows from the solder-joined portion 101 and flows into the recess portion 40, thereby increasing the risk of impairing the stress relaxation function of the recess portion 40.

When the recess portion 40 is formed on the outer side of the base 35 as illustrated in FIG. 1A, a position A of a bottom face of the recess portion 40 is desirably approximately at the same level or lower than a lowest part B of the solder-joined portion 101. This is because the solder-joined portion 101 is less affected by the rigidity of the base 35 in an approximately horizontal direction.

Furthermore, a thickness tb (hereinafter referred to as wall thickness) from the bottom face of the recess portion 40 to a surface of the base 35 on the opposite side to the side formed with the recess portion 40 is desirably not less than 0.5 mm. This is because a wall thickness tb of less than 0.5 mm may cause deformation when a connecter insertion/extraction force is applied during a production process.

While the recess portion 40 is formed at an outside part of the base 35 in the cross-sectional view illustrated in FIG. 1A, alternatively the recess portion 40 may be formed at an inside part of the base 35. The stress relaxation effect on the solder-joined portion 101 is obtained similar to the case when the recess portion 40 is formed at the outside part of the base 35, since the base 35 near the recess portion 40 becomes readily deformable.

While the recess portion 40 is formed on the base 35 in the outer periphery of the feedthrough 32 so as to surround the feedthrough 32 in FIG. 1B, alternatively the recess portion 40 may be partially formed in the outer periphery of the feedthrough 32 as illustrated in FIG. 1C. Even when the recess portion 40 is partially formed on the outer periphery of the feedthrough 32 as illustrated in FIG. 1C, cracks in the solder-joined portion 101 can be prevented and low-density gas leakage paths can be suppressed if the recess portion 40 is able to reduce the load applied to the solder-joined portion 101.

### Second Embodiment

A second embodiment will be described with reference to FIG. 2. FIG. 2A is a cross-sectional view of a joining structure of a magnetic disk in which a recess portion 40 is formed without penetrating the base, at least one portion in a periphery of a solder-joined portion 101 joining the base 35 and a feedthrough 32, that does not penetrate the base 35. Further, the solder-joined portion 101 is segmented by inserting a member 50 into the solder-joined portion 101. In addition, FIG. 2B illustrates a top view of the joining structure illustrated in FIG. 2A. FIG. 2A is a cross-sectional view taken along X-Y in FIG. 2B. The member 50 is inserted into the solder-joined portion 101 joining the feedthrough 32 and the base 35 and segments the solder-joined portion 101 into an inner part and an outer part.

While the stress acting on the solder-joined portion 101 can be reduced by increasing the total amount of the solder 101, an increase in the total solder amount may cause segregation over a wide area since the large amount of solder are solidified in a soldering process and formation of a huge shrinkage, thereby creating a risk of premature leakage path formation.

In consideration thereof, not only increase of the total amount of solder, but also segmentation of the solder-joined portion 101 by inserting the member 50 into the solder-joined portion 101 enables to suppress an occurrence of segregation and, in turn, suppress an occurrence of a huge shrinkage cavity, delaying leakage path formation. In this case, a plate such as metal plat or a member having a honeycomb structure that has wettability with the solder is desirably used as the member 50. This is because good solder wettability improves joint reliability.

In addition, the member 50 is desirably disposed approximately at the center of the solder-joined portion 101 and has a shape that can approximately evenly split it. An occurrence of a shrinkage cavity can be suppressed more effectively when the solder-joined portion 101 is segmented by the member and widths W1, W2 of the segmented solder-joined portion 101 are not more than 1 mm.

While the solder-joined portion 101 is segmented by a single member 50 into two parts, namely, the inner part and the outer part in FIG. 2B, alternatively the solder material 101 can be segmented into a plurality of parts by providing a plurality of members 50 in the solder-joined portion 101 as illustrated in FIG. 2C. When the solder-joined portion 101 is segmented finer by the members at a plurality of locations as compared to having a member at one location, a huge shrinkage cavity is more effectively suppressed and leakage path formation is further delayed compared to the case having a member at one location.

In view of distributing stress generated at the flange 31, the base 35 and the like, a plurality of recess portions not penetrating the base 35 may be formed.

### Third Embodiment

A third embodiment will be described with reference to FIG. 3. FIG. 3A is a cross-sectional view of a joining structure in which a base 35 and a feedthrough 32 are joined by a solder-joined portion 101, and non-penetrating recess portions are respectively formed on both an inside part and an outside part on the base 35 in a periphery of the solder-joined portion 101. In addition, a top view of the joining structure is illustrated in FIG. 3B. FIG. 3A is a cross-sectional view taken along X-Y in FIG. 3B. A recess portion 40b is formed on the inside part of the base 35 so as to enclose the feedthrough 32, and a recess portion 40a is further formed on the outside part of the base 35 so as to enclose the recess portion 40b.

By the recess portions on both inner and outer sides of the base 35, the deformability of the base 35 is improved in comparison to a case where a recess portion is formed only on one side of the base 35. Therefore, stress acting on the solder-joined portion 101 can be distributed to the base 35 more effectively than the case where a recess portion is formed only on one side.

When another recess portion is to be formed in the vicinity of a recess portion formed on the inner side of the base 35, another recess portion is formed on the outer side of the base 35. when another recess portion is to be formed in the vicinity of a recess portion formed on the outer side of the base 35, another recess portion is formed on the inner side of the base 35. Therefore, a zigzag spring structure can be created, that is readily expanded/contracted towards the inner and outer sides of the base 35. Therefore, the stress acting on the solder-joined portion 101 can be further distributed towards the base 35 in comparison to a case where the inner and outer sides of the base 35 are each formed with a single recess portion.

When the base 35 is provided with a plurality of recess portions, a spacing t between the recess portions desirably ranges from 0.5 mm (inclusive) to 1.6 mm (inclusive). This is because a spacing t of less than 0.5 mm may result in insufficient strength of the base 35 between the recess portions and may cause deformation when a connecter insertion/extraction force is applied during a production process. When the spacing t is greater than 1.6 mm, it will be difficult to distribute the generated stress to the outer-side recess portion due to the rigidity of the base 35.

In addition, as illustrated in FIG. 3C, instead of having the recess portion 40 surrounding the feedthrough 32, a plurality of recess portions 40 may be partially formed at an outer peripheral part of the feedthrough 32. When deformability of the base 35 may be increased due to the partially provided plurality of recess portions 40, the stress acting on the solder-joined portion 101 can be alleviated and a stress relaxation effect is achieved. Furthermore, the plurality of recess portions 40 may be formed only on the same one side of the base 35.

Moreover, three or more recess portions not penetrating the base 35 may be formed. In addition, the number of recess portions to be formed on the inner and outer sides of the base 35 may be arbitrarily determined. Furthermore, the number of recess portions consecutively formed on the same one side of the base 35 may also be arbitrarily determined. The positions and the number of recess portions are not limited to those described in the present embodiment.

### Fourth Embodiment

A fourth embodiment will be described with reference to FIG. 4. FIG. 4A is a cross-sectional view of a joining structure of a magnetic disk in which a recess portion 40 not penetrating a base 35 is formed at least one location in a periphery of a solder-joined portion 101 joining the base 35 and a feedthrough 32, and solder, an adhesive or the like 60 is supplied in at least one recess portion 40. FIG. 4B illustrates a top view of the joining structure. FIG. 4A is a cross-sectional view taken along X-Y in FIG. 4B.

As shown in the first embodiment, the base 35 with the recess portion 40 can be readily deformed near the recess portion 40, and thermomechanical load on the solder-joined portion 101 is reduced. However, when the thickness of the bottom of the recess portion 40 is too thin, too much stress acts on a thickness of the bottom of the recess portion 40 as compared to the case where the solder-joined portion 101 is subjected to a stress relaxation means, and thus a rupture of the bottom of the recess portion 40 problematically occurs. Thus, solder, an adhesive or the like are supplied in at least one recess portion 40, so that stress relaxation can be applied at the thickness part of the bottom of the recess portion 40. Thus, the strength of the base 35 and the deformability of the solder or the adhesive are combined, and the strength of the recess portion 40 can be readily adjusted with dimensions of the recess portion 40 and the quantity of the supplied solder or the adhesive 60. As a result, leakage of the low-density gas hermetically sealed in the base 35 to the outside thereof can be delayed.

While the recess portion 40 is formed only at one location in FIG. 4, recess portions 40 may be provided at a plurality of locations, and the solder or adhesive 60 may be supplied to a part of or all of the one or more recess portions 40.

Furthermore, one or more plates such as metal plate or a member having a honeycomb structure that have wettability with the solder may be inserted into the solder-joined portion 101 although it are not shown in FIG. 4. When such members are inserted, segregation can be suppressed by segmenting the solder-joined portion 101. In turn, an occurrence of a huge shrinkage cavity may be suppressed and leakage path formation may be delayed.

Next, heat cycle tests were conducted to evaluate a low-density gas seal lifetime of the hermetically-sealed magnetic disk devices described above.

### Experiment 1

In order to produce a hermetically-sealed magnetic disk device for hermetically sealing a low-density gas, as illustrated in FIG. 1A, prepared were an elliptical through-hole in which a feedthrough 32 is joined that seals the low-density gas, and a base 35 provided with a non-penetrating recess portion 40 that makes a circuit around the periphery of a solder-joined portion 101 joining the base 35 and the feedthrough 32. A gap of 0.75 mm was created between the elliptical through-hole and the feedthrough 32. The non-penetrating recess portion 40 making a circuit around the periphery of the solder-joined portion 101 had a width W of 1.6 mm and a depth of 1.4 mm, and a wall thickness tb of the bottom of the recess portion 40 was set to 0.6 mm.

The feedthrough 32 was fixed using a Teflon (registered trademark) jig when disposing the feedthrough 32 on the base 35 so as to adjust the positional relationship between the base 35 and the feedthrough 32.

A solder 101 used to join the base 35 and the feedthrough 32 had a composition of Sn-3Ag-0.5Cu (unit: weight percent) and was configured as a solder wire having a diameter of 1.0 mm and circuiting an outer peripheral shape (elliptical shape) of the feedthrough 32.

The quantity of the supplied solder wire or, in other words, the number of elliptical circuits was set to 4 around a part joining the base 35 and the feedthrough 32.

After disposing the solder, a flux containing 2%-chlorine was supplied and soldering was performed in a reflow furnace to produce a hermetically-sealed magnetic disk device that hermetically seals a low-density gas in a joined space.

In addition, a hermetically-sealed magnetic disk device for comparison was produced using a base not provided with a recess portion.

A total of 20 magnetic disk devices, 10 for each condition, were prepared and helium was used as the low-density gas. Magnetic disk devices with a leak rate equal to or lower than 1×10⁻¹¹ (Pa·m³/sec) were judged to be acceptable. Results of the numbers of samples achieving a target actual lifespan of 7 years were as follows.
Hermetically-sealed magnetic disk device provided with the recess portion 40: 10 for 10
Hermetically-sealed magnetic disk device not provided with the recess portion 40: 7 for 10

Consequently, it was found to be effective in improving the seal reliability of solder with respect to the low-density gas that a non-penetrating recess portion 40 is formed around the periphery of the solder-joined portion 101. This is because the recess portion 40 enables the base 35 near the recess portion 40 to be readily deformed, and stress generated on the respective members due to a temperature change of a product from environment of the product or heat from the product can be distributed to the base 35 near the recess portion 40 as well as the solder-joined portion 101. As a result, thermomechanical load on the solder-joined portion 101 could be reduced to prevent the occurrence of cracks at the solder-joined portion 101 and to suppress low-density gas leakage paths.

### Experiment 2

In order to produce a hermetically-sealed magnetic disk device for hermetically sealing a low-density gas, prepared were a base 35 comprising an elliptical through-hole for joining a feedthrough 32 sealing the low-density gas, and a base 35 provided with a non-penetrating recess portion 40 circuiting around the periphery of a solder-joined portion 101 joining the base 35 and the feedthrough 32. A gap of 1.5 mm was created between the elliptical through-hole and the feedthrough 32. The non-penetrating recess portion 40 circuiting around the periphery of the solder-joined portion 101 had a width of 1.6 mm and a depth of 1.4 mm, and a wall thickness of the bottom of the recess portion 40 was set to 0.6 mm.

The feedthrough 32 was fixed using a Teflon (registered trademark) jig when disposing the feedthrough 32 on the base 35 so as to adjust the positional relationship between the base 35 and the feedthrough 32.

In doing so, a plate having a thickness of 0.15 mm and made of nickel was fixed to the Teflon (registered trademark) jig so as to segment a solder of the solder-joined portion 101 into two parts, as illustrated in FIG. 2A.

The solder used to join the base 35 and the feedthrough 32 had a composition of Sn-3Ag-0.5Cu (unit: weight percent) and was configured as a solder wire having a diameter of 1.0 mm and circuiting an outer peripheral shape (elliptical shape) of the feedthrough 32.

The quantity of the supplied solder wire or, in other words, the number of elliptical circuits was set to 4 around an inner side and 2 around an outer side of the plate of 0.15 mm thick and made of nickel at a part used to join the base 35 and the feedthrough 32.

After disposing the solder, a flux with 2%-chlorine was supplied and soldering was performed in a reflow furnace to produce a hermetically-sealed magnetic disk device that hermetically seals a low-density gas in a joined space.

In addition, a magnetic disk device for comparison was also prepared in which a plate having a thickness of 0.15 mm and made of nickel was not fixed to the Teflon (registered trademark) jig and the quantity of the supplied solder wire or, in other words, the number of elliptical circuits was set to 6, thereby not segmenting the solder of the solder-joined portion 101.

A total of 20 magnetic disk devices, 10 for each condition, were prepared and helium was used as the low-density gas. Magnetic disk devices with a leak rate equal to or lower than 1×10⁻¹¹ (Pa·m³/sec) were judged to be acceptable. Results of the numbers of samples achieving a target actual lifespan of 10 years were as follows.
Hermetically-sealed magnetic disk device with a segmented solder-joined portion 101: 10 for 10
Hermetically-sealed magnetic disk device with a non-segmented solder-joined portion 101: 7 for 10

As a result, it was found to be effective in improving the seal reliability of the solder with respect to the low-density gas that the solder of the solder-joined portion 101 is segmented. This is because the inserted member 50 segments the solder-joined portion 101 and can suppress segregation and, in turn, suppress an occurrence of a huge shrinkage cavity and delay of leakage path formation.

### Experiment 3

In order to produce a hermetically-sealed magnetic disk device for hermetically sealing a low-density gas, prepared were a base 35 comprising an elliptical through-hole for joining a feedthrough 32 sealing the low-density gas, and a non-penetrating recess portion 40 circuiting around the periphery of a solder-joined portion 101 joining the base 35 and the feedthrough 32. As illustrated in FIG. 3A, a gap of 0.75 mm was created between the elliptical through-hole and the feedthrough 32. In addition, a total of two recess portions, one on an inner side and another on an outer side of the base 35, were formed in the periphery of the solder-joined portion 101. The recess portion 40 had a width of 0.8 mm and a depth of 1.4 mm, and a wall thickness of the bottom of the recess portion 40 was set to 0.6 mm.

The feedthrough 32 was fixed using a Teflon (registered trademark) jig when disposing the feedthrough 32 on the base 35 so as to adjust the positional relationship between the base 35 and the feedthrough 32.

The solder used to join the base 35 and the feedthrough 32 had a composition of Sn-3Ag-0.5Cu (unit: weight percent) and was configured as a solder wire having a diameter of 1.0 mm and circuiting an outer peripheral shape (elliptical shape) of the feedthrough 32.

The quantity of the supplied solder wire or, in other words, the number of elliptical circuits was set to 4 around a part used to join the base 35 and the feedthrough 32.

After disposing the solder, a flux with 2%-chlorine was supplied and soldering was performed in a reflow furnace to produce a hermetically-sealed magnetic disk device that hermetically seals a low-density gas in a joined space.

In addition, a hermetically-sealed magnetic disk device for comparison was produced using a base provided with two recess portions only on the outer side of the base 35 in the periphery of the solder-joined portion 101.

A total of 20 magnetic disk devices, 10 for each condition, were prepared and helium was used as the low-density gas. Magnetic disk devices with a leak rate equal to or lower than 1×10⁻¹¹ (Pa·m³/sec) were judged to be acceptable. Results of the numbers of samples achieving a target actual lifespan of 10 years were as follows.
Hermetically-sealed magnetic disk devices provided with one recess portion 40 respectively on the inner and outer sides of the base 35: 10 for 10
Hermetically-sealed magnetic disk devices provided with two recess portions 40 only on the outer side of the base 35: 9 for 10

As a result, it was found to be effective in improving the seal reliability of the solder with respect to the low-density gas that the recess portion 40 is formed on the inner and outer sides of the base 35. This is because the deformability of the base 35 is improved by the recess portions 40 on both sides of the base 35 in comparison to a case where a recess portion 40 is only formed on the outer side of the base 35. Therefore, stress acting on the solder-joined portion 101 can be distributed to the base 35 more effectively than the case where a recess portion 40 is not formed.

### Experiment 4

In order to produce a hermetically-sealed magnetic disk device for hermetically sealing a low-density gas, prepared were a base 35 comprising an elliptical through-hole for joining a feedthrough 32 sealing the low-density gas, and a non-penetrating recess portion circuiting around the periphery of a solder-joined portion 101 joining the base 35 and the feedthrough 32.

A gap of 0.75 mm was provided between the elliptical through-hole and the feedthrough 32. In addition, a total of four non-penetrating recess portions circuiting around a periphery of the solder-joined portion 101 were formed, two each provided on an inner side and an outer side of the base 35. The recess portions had a width of 0.8 mm and a depth of 1.4 mm, and a wall thickness of the bottom of the recess portion was set to 0.6 mm.

A hermetically-sealed magnetic disk device was produced using a base 35 where the two recess portions formed on the inner side of the base 35 and the two recess portions formed on the outer side of the base 35 are respectively adjacent to each other, and a hermetically-sealed magnetic disk device was also produced using a base 35 where neither the two recess portions provided on the inner side of the base 35 nor the two recess portions formed on the outer side of the base 35 are adjacent to each other. Hereinafter, for simplicity, the base used in the former hermetically-sealed magnetic disk device will be referred to as specification A and the base used in the latter hermetically-sealed magnetic disk device will be referred to as specification B.

The feedthrough 32 was fixed using a Teflon (registered trademark) jig when disposing the feedthrough 32 on the base 35 so as to adjust the positional relationship between the base 35 and the feedthrough 32.

The solder used to join the base 35 and the feedthrough 32 had a composition of Sn-3Ag-0.5Cu (unit: weight percent) and was configured as a solder wire having a diameter of 1.0 mm and circuiting an outer peripheral shape (elliptical shape) of the feedthrough 32.

The quantity of the supplied solder wire or, in other words, the number of elliptical circuits was set to 4 around a part used to join the base 35 and the feedthrough 32.

After disposing the solder, a flux with 2%-chlorine was supplied and soldering was performed in a reflow furnace to produce a hermetically-sealed magnetic disk device that hermetically seals a low-density gas in a joined space.

A total of 20 magnetic disk devices, 10 for each condition, were prepared and helium was used as the low-density gas. Magnetic disk devices with a leak rate equal to or lower than 1×10⁻¹¹ (Pa·m³/sec) were judger to be acceptable. Results of the numbers of samples achieving a target actual lifespan of 10 years were as follows.
Hermetically-sealed magnetic disk device using the specification A base 35: 9 for 10
Hermetically-sealed magnetic disk device using the specification B base 35: 10 for 10

As a result, it was found to be effective in improving the seal reliability of the solder with respect to the low-density gas that the recess portions are formed on the same sides of the base 35 so as not to be adjacent to each other. This is because a zigzag spring structure is created that is readily expanded/contracted towards the inner and outer sides of the base 35 and can distribute stress acting on the solder-joined portion 101 further towards the base 35 in comparison to a case where the inner and outer sides of the base 35 are each provided with a recess portion.

### Experiment 5

In order to produce a hermetically-sealed magnetic disk device for hermetically sealing a low-density gas, prepared were a base 35 comprising an elliptical through-hole for joining a feedthrough 32 sealing the low-density gas, and a non-penetrating recess portion circuiting around the periphery of a solder-joined portion 101 joining the base 35 and the feedthrough 32.

As illustrated in FIG. 4A, a gap of 0.75 mm was created between the elliptical through-hole and the feedthrough 32, and solder was supplied to the non-penetrating recess portion circuiting around the periphery of the solder-joined portion 101. The recess portion had a width of 1.6 mm and a depth of 1.4 mm, and a wall thickness of the bottom of the recess portion was set to 0.6 mm.

The feedthrough 32 was fixed using a Teflon (registered trademark) jig when disposing the feedthrough 32 on the base 35 so as to adjust the positional relationship between the base 35 and the feedthrough 32.

The solder used to join the base 35 and the feedthrough 32 had a composition of Sn-3Ag-0.5Cu (unit: weight percent) and was configured as a solder wire having a diameter of 1.0 mm and circuiting an outer peripheral shape (elliptical shape) of the feedthrough 32.

The quantity of the supplied solder wire or, in other words, the number of elliptical circuits was set to 4 around a part used to join the base 35 and the feedthrough 32 and to 3 around the part of the non-penetrating recess portion so as to conform to the size of the recess portion.

After disposing the solder, a flux with 2%-chlorine was supplied and soldering was performed in a reflow furnace to produce a hermetically-sealed magnetic disk device that hermetically seals a low-density gas in a joined space.

In addition, a hermetically-sealed magnetic disk device for comparison was produced using a base 35 where solder is not supplied to the recess portion.

A total of 20 magnetic disk devices, 10 for each condition, were prepared and helium was used as the low-density gas. Magnetic disk devices with a leak rate equal to or lower than 1×10⁻¹¹ (Pa·m³/sec) were judged to be acceptable. Results of the numbers of samples achieving a target actual lifespan of 7 years were as follows.
Hermetically-sealed magnetic disk device using a base with solder supplied to the recess portion: 10 for 10
Hermetically-sealed magnetic disk device using a base without solder supplied to the recess portion: 7 for 10

Consequently, it was found to be effective in improving the seal reliability of solder with respect to the low-density gas to supply solder to a non-penetrating recess portion circuiting around the periphery of the solder-joined portion 101. This is because supplied solder or an adhesive to the recess portion can alleviate the stress on the thick part of the recess portion. The strength of the base 35 and the deformability of the solder or the adhesive can be combined, and the strength of the recess portion can be readily adjusted by dimensions of the recess portion and the quantity of the supplied solder or the adhesive. As a result, leakage of the low-density gas hermetically sealed in the base 35 to the outside thereof can be delayed.

While the invention made by the present inventors has been described in preferred embodiments thereof, it is to be understood that the present invention is not limited thereto and various changes and modifications may be made without departing from the spirit and the scope of the present invention.

Moreover, the member to be inserted into the solder-joined portion 101 as illustrated in FIG. 2A are not necessarily a plate or a member having a honeycomb structure, and may be any material capable of segmenting the solder-joined portion 101.

In addition, the positions and the number of recess portions not penetrating the base 35 as illustrated in FIG. 3A can be arbitrarily determined. Furthermore, the solder or adhesive to be supplied to the recess portion in FIG. 4A may be any material as long as the strength and the deformability of the base 35 can be combined and the strength of the recess portion can be readily adjusted by the dimensions of the recess portion or the like.

Moreover, the recess portion of the base 35 is desirably positioned such that the distance between the solder-joined portion 101 and the recess portion ranges from 0.5 mm (inclusive) to 1.6 mm (inclusive). As the recess portion is closer to the solder-joined portion 101, the stress relaxation effect becomes greater. However, a distance of less than 0.5 mm increases the risk of molten solder flowing into the recess portion 40 from the solder-joined portion 101. In addition, a distance greater than 1.6 mm makes it difficult to distribute stress acting on the solder-joined portion 101 to the recess portion since the rigidity of a chassis at the part of the base 35 between the solder-joined portion 101 and the recess portion increases.

While certain embodiments have been described above, it will be obvious to those skilled in the art that the present invention is not limited to the above embodiments and that various modifications and changes may be made without departing from the scope and spirit of the invention.

Other objects, features and advantages of the invention will become apparent from the following description of the embodiments of the invention taken in conjunction with the accompanying drawings.

### BRIEF DESCRIPTION OF THE DRAWINGS

FIG. 1A is a cross-sectional view of a first embodiment of a joining structure according to the present invention;

FIG. 1B is a top view of the first embodiment of the joining structure according to the present invention;

FIG. 1C is a diagram illustrating a modification of the first embodiment of the joining structure according to the present invention;

FIG. 2A is a cross-sectional view of a second embodiment of the joining structure according to the present invention;

FIG. 2B is a top view of the second embodiment of the joining structure according to the present invention;

FIG. 2C is a diagram illustrating a modification of the second embodiment of the joining structure according to the present invention;

FIG. 3A is a cross-sectional view of a third embodiment of the joining structure according to the present invention;

FIG. 3B is a top view of the third embodiment of the joining structure according to the present invention;

FIG. 3C is a diagram illustrating a modification of the third embodiment of the joining structure according to the present invention;

FIG. 4A is a cross-sectional view of a fourth embodiment of the joining structure according to the present invention;

FIG. 4B is a top view of the fourth embodiment of the joining structure according to the present invention;

FIG. 5 illustrates a top view of a hermetically-sealed magnetic disk device according to a conventional example, from which a cover of a chassis has been removed;

FIG. 6 is a cross-sectional view of a hermetically-sealed magnetic disk device according to a conventional example;

FIG. 7 is a cross-sectional view of a joining structure of a hermetically-sealed magnetic disk device according to a conventional example;

FIG. 8 is a top view of a joining structure of a hermetically-sealed magnetic disk device according to a conventional example; and

FIG. 9 is an enlarged view of a cross section illustrating a conventional joint portion of a feedthrough and a base.

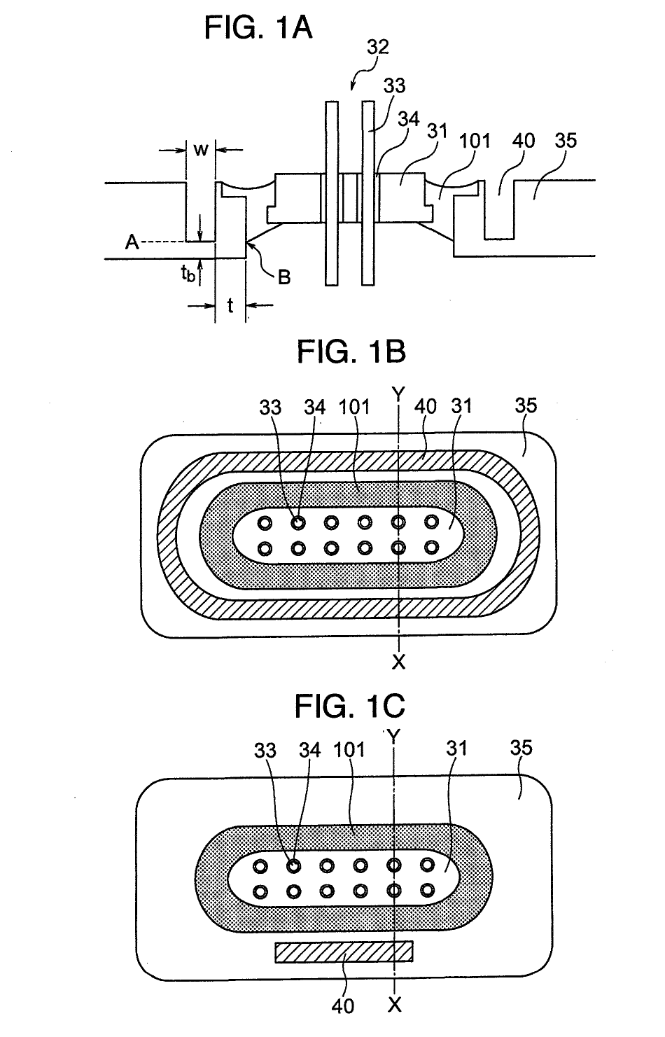

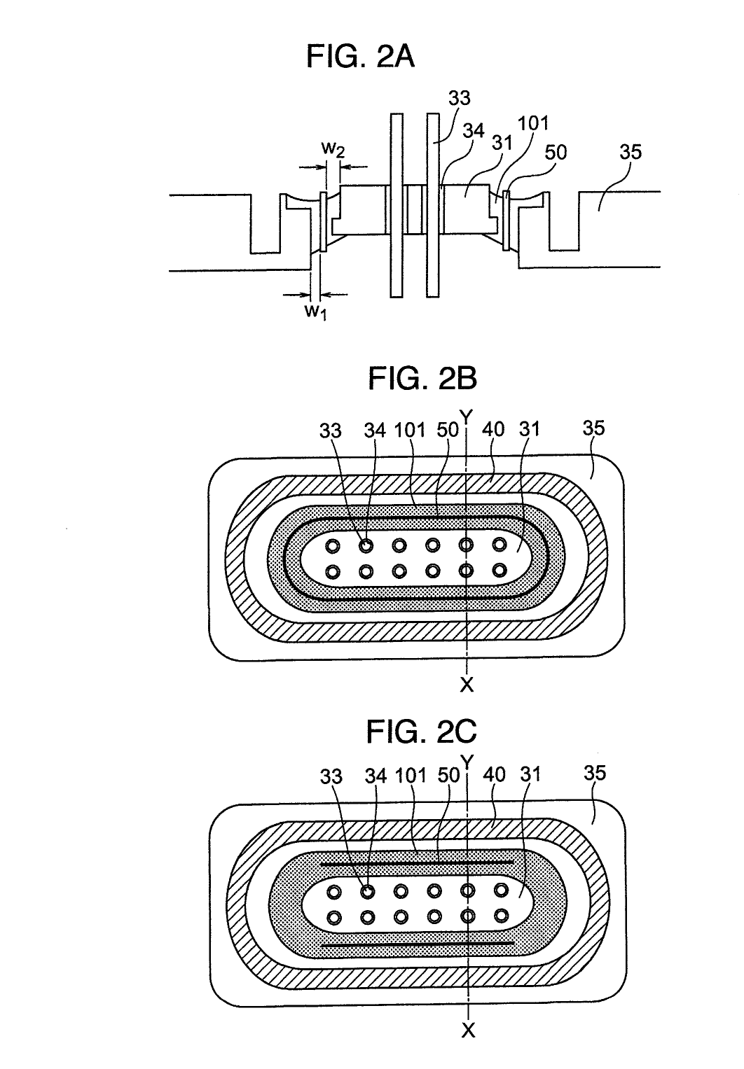

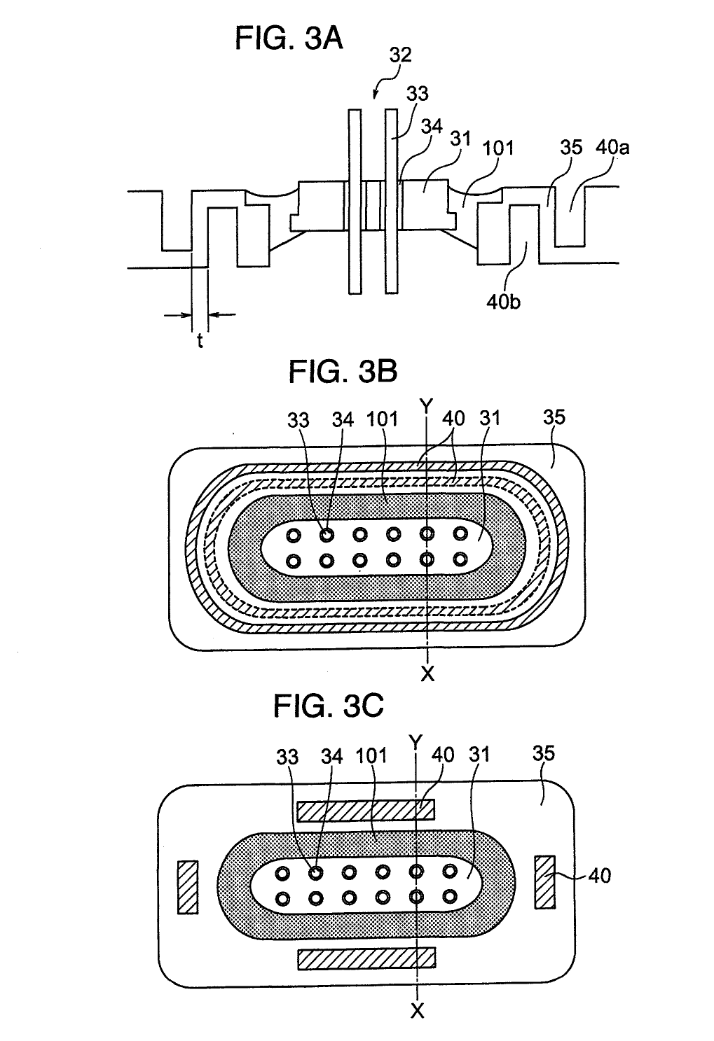

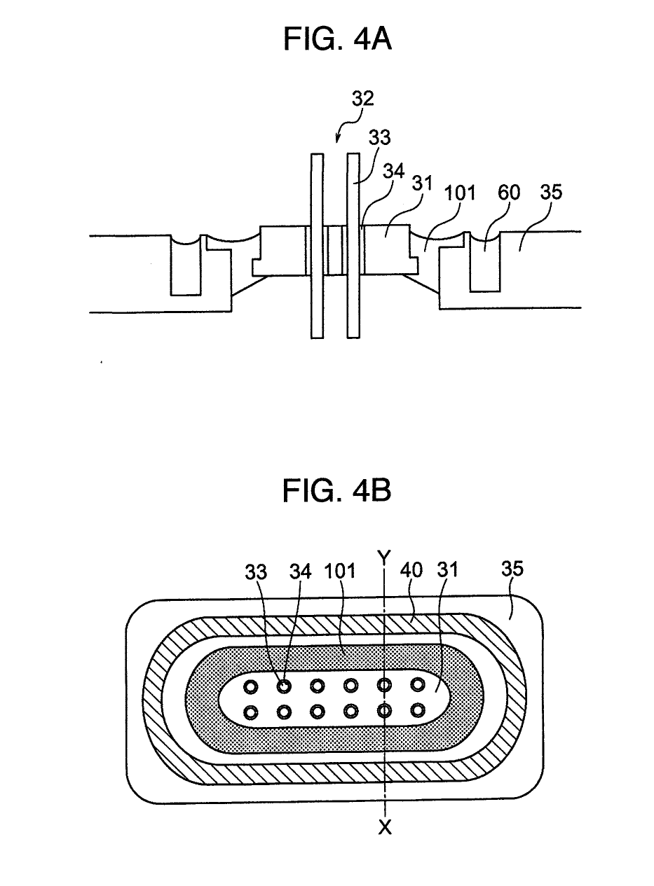

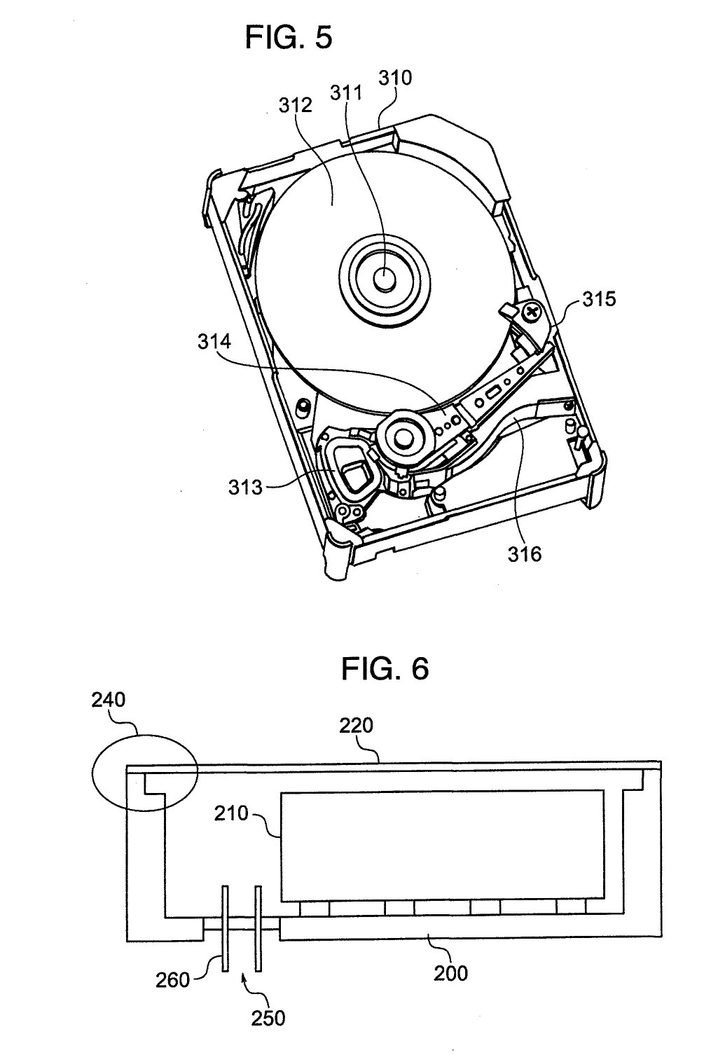

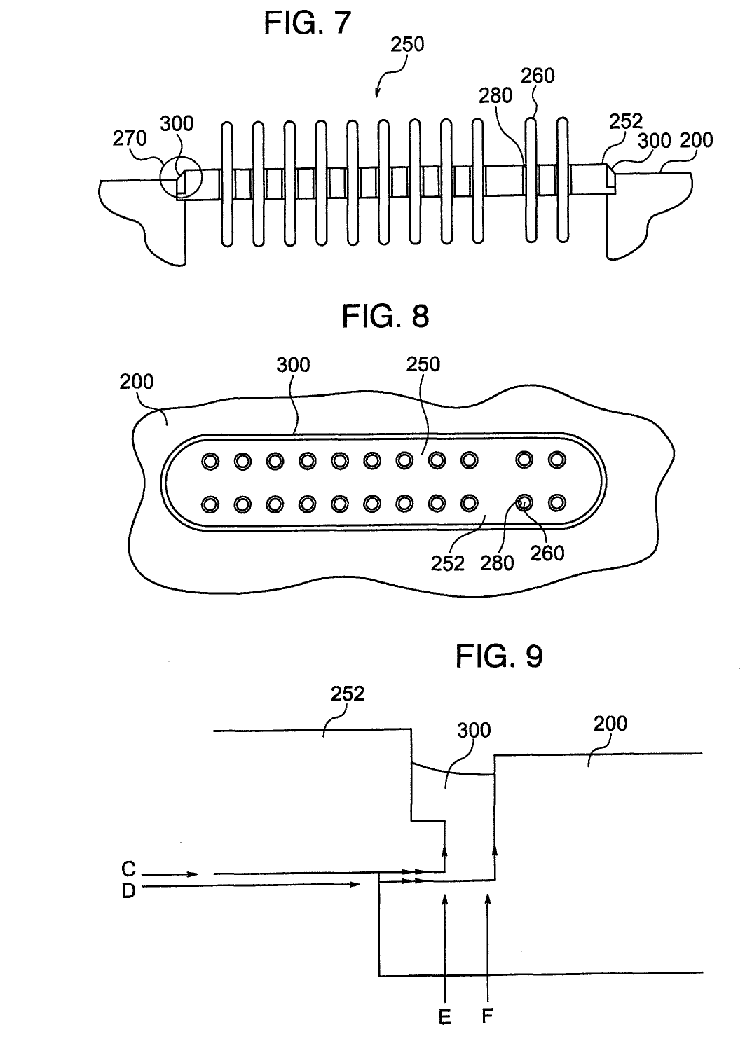

### DESCRIPTION OF REFERENCE NUMERALS

35, 200, 310 base
311 spindle motor
312 magnetic disk
313 actuator assembly
314 head gimbal assembly
315 magnetic head
316 FPC assembly
101, 300 solder-joined portion
31, 252 flange
40a, 40b, 40 recess portion
34, 280 sealing material
33, 260 electrical signal transmitting steel pin
32, 250 feedthrough
50 member
60 solder, adhesive, or the like
310 apparatus constituent device
220 cover
240, 270 joint position

1. A magnetic disk device comprising:
a magnetic disk;
a magnetic head recording/reproducing information onto/from the magnetic disk;
a base;
a feedthrough joined to the base by solder; and
a solder-joined portion that joins the base and the feedthrough, wherein
a recess portion is formed on the base in the periphery of the solder-joined portion.

2. The magnetic disk device according to claim 1, wherein
a plurality of the recess portions are formed.

3. The magnetic disk device according to claim 2, wherein
the recess portions are formed respectively on a first face-side and a reverse side of the first face of the base.

4. The magnetic disk device according to claim 3, wherein
the recess portions are formed alternately on the first face-side and a reverse side of the first face of the base.

5. The magnetic disk device according to claim 1, comprising a member segmenting the solder-joined portion in the solder-joined portion.

6. The magnetic disk device according to claim 5, wherein
the member is a metallic member.

7. The magnetic disk device according to claim 5, wherein
the member is a plate or a member having a honeycomb structure.

8. The magnetic disk device according to claim 5, wherein
the member has wettability.

9. The magnetic disk device according to claim 5, wherein
a plurality of the members are inserted into the solder-joined portion.

10. The magnetic disk device according to claim 1, wherein
the recess portion has solder or an adhesive therein.

11. The magnetic disk device according to claim 1, wherein
the recess portion surrounds the feedthrough.

12. The magnetic disk device according to claim 1, wherein
the recess portion is partially formed in an outer periphery of the feedthrough.
